(19) United States
(12) Patent Application Publication
(10) Pub. No.: US 2009/0074475 A1
(43) Pub. Date: Mar. 19, 2009

(54) Transfer Device and Image Forming Apparatus Including the Same

(75) Inventor: Koichi KAMIJO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/201,923

(22) Filed: Aug. 29, 2008

(30) Foreign Application Priority Data
Sep. 13, 2007 (JP) 2007-237786
Jun. 3, 2008 (JP) 2008-145726

(51) Int. Cl. G03G 15/16

(52) U.S. Cl. 399/297

(57) ABSTRACT

A transfer device includes: an image carrier belt having a base layer and an elastic layer; a first roller around which the image carrier belt is wound; a second roller around which the image carrier belt wound around the first roller and shifted; a third roller contacting the first roller via the image carrier belt; and a fourth roller contacting the second roller via the image carrier belt. A hardness H4 of the fourth roller and a hardness H6 of the image carrier belt on the second roller when the image carrier belt is wound around the second roller have as the relationship of H6<H4.

### BACKGROUND

1. Technical Field

The present invention relates to a transfer device for transferring liquid developer image transferred on an image carrier belt onto a transfer material such as paper, and to an image forming apparatus including the transfer device.

2. Related Art

Currently, such a type of liquid developer image forming apparatus has been proposed which includes a transfer unit for transferring a liquid developer image transferred on an image carrier belt onto a transfer material such as paper (for example, see JP-A-2001-166611). According to the transfer device included in the image forming apparatus disclosed in JP-A-2001-166611, a transfer roller is pressed against the image carrier belt such that the image carrier belt can be wound around the transfer roller. As a result, a circular arc transfer nip having a nip shape and a predetermined width in the shift direction of the transfer material is produced to provide preferable transfer characteristics.

According to the transfer device shown in JP-A-2001-166611, the transfer nip having a certain width is obtained in the shift direction of the transfer material. However, the possible width of the transfer nip to be produced is limited due to the structure which winds the image carrier belt around the transfer roller. Thus, improvement over the transfer efficiency is limited and difficult to be further raised.

Additionally, since the nip shape of the transfer nip is a circular arc having the same radius of curvature as that of the transfer roller and the predetermined width, the transfer material reaching the transfer nip is forcefully curved into a circular arc having the same shape. Thus, passing smoothness and separability of the transfer material at the transfer nip are not preferable.

### SUMMARY

It is an advantage of some aspects of the invention to provide a transfer device capable of increasing transfer efficiency and improving passing smoothness and separability of transfer material at a transfer nip, and an image forming apparatus including the transfer device.

A transfer device according to a first aspect of the invention includes: an image carrier belt having a base layer and an elastic layer; a first roller around which the image carrier belt is wound; a second roller around which the image carrier belt wound around the first roller and shifted; a third roller contacting the first roller via the image carrier belt; and a fourth roller contacting the second roller via the image carrier belt. A hardness H4 of the fourth roller and a hardness H6 of the image carrier belt on the second roller when the image carrier belt is wound around the second roller have the relationship of H6<H4. According to the structure which includes the image carrier belt having the elastic layer, transferability on a transfer material having large concaves and convexes improves, and thus clear images can be transferred on concaves. Moreover, the transfer material shifts while closely contacting the image carrier belt from the start position of the first transfer nip to the end position of the second transfer nip. Thus, preferable transfer can be performed. In addition, the transfer material is not greatly curved during shift, and the passing smoothness of the transfer material can be enhanced. In the condition H6<H4, a curved surface concaved on the second roller side is formed at the second transfer nip. Thus, separability of the transfer material is increased, and winding of the transfer material around the image carrier belt is prevented.

It is preferable that the relationship between the hardness H4 of the fourth roller, a hardness H1 of the second roller, and a hardness H5 of the elastic layer of the image carrier belt have the relationship of H4≧H1 and H1>H5. The elastic layer of the image carrier belt contributes to the formation of the curved surface at the second transfer nip concaved on the second roller side. As a result, separability of the transfer material is enhanced, and winding of the transfer material around the image carrier belt is prevented.

It is preferable that the relationship between the hardness H2 of the first roller, a hardness H3 of the third roller, and the hardness H5 of the elastic layer of the image carrier belt have the relationship of H2>H3 and H3≧H5. According to this structure, the hardness of the third roller is equal to or larger than the hardness of the elastic layer of the image carrier belt. Thus, the elastic layer of the image carrier belt contributes to the formation at the curved surface of the first transfer nip concaved on the third roller side. Accordingly, transferability and collect capability of carrier improve.

It is preferable that a press contact load between the first roller and the third roller contacting each other via the image carrier belt is larger than a press contact load between the second roller and the fourth roller contacting each other via the image carrier belt. According to this structure, the press contact load on the first transfer nip is larger than the press contact load on the second transfer nip. Thus, the function for increasing transferability at the first transfer nip and the function for increasing separability of the transfer material at the second transfer nip further improve.

It is preferable that the outside diameter of the second roller is larger than the outside diameter of the fourth roller. In this structure, separability of the transfer material at the second transfer nip is further increased.

A transfer device according to a second aspect of the invention includes: an image carrier belt having a base layer and an elastic layer; a first roller around which the image carrier belt is wound; a second roller around which the image carrier belt wound around the first roller and shifted; a third roller contacting the first roller via the image carrier belt; a fourth roller contacting the second roller via the image carrier belt; a transfer belt around which the third and fourth rollers are wound. A hardness H7 of the transfer belt on the fourth roller when the transfer belt is wound around the fourth roller and a hardness H6 of the image carrier belt on the second roller when the image carrier belt is wound around the second roller have the relationship of H6<H7. According to the structure including the image carrier belt having the elastic layer, transferability on a transfer material having large concaves and convexes improves, and thus clear images can be transferred on concaves. Moreover, the transfer material shifts while sandwiched between the image carrier belt and the image support belt and closely contacting the image carrier belt from the start position of the first transfer nip to the end position of the second transfer nip. Thus, preferable transfer can be performed. In addition, the transfer material is not greatly curved during shift, and the passing smoothness of the transfer material can be enhanced. In the condition H6<H7, the second transfer nip forms a curved surface concaved on the second roller side. Thus, separability of the transfer material is enhanced, and winding of the transfer material around the image carrier belt is prevented.

It is preferable that the relationship between the hardness H4 of the fourth roller, a hardness H1 of the second roller, and a hardness H5 of the elastic layer of the image carrier belt have the relationship of H4≧H1 and H1>H5. According to this structure, a curved surface concaved on the second roller side is formed at the second transfer nip. Thus, separability of the transfer material is enhanced, and winding of the transfer material around the image carrier belt is prevented.

It is preferable that the relationship between the hardness H2 of the first roller, a hardness H3 of the third roller, and that the hardness H5 of the elastic layer of the image carrier belt have the relationship of H2>H3 and H3≧H5. According to this structure, the hardness of the third roller is equal to or larger than the hardness of the elastic layer of the image carrier belt. Thus, the elastic layer of the image carrier belt contributes to the formation of the curved surface of the first transfer nip concaved on the third roller side. Accordingly, transferability and collect capability of carrier improve.

It is preferable that a press contact load between the first roller and the third roller contacting each other via the image carrier belt and the transfer belt is larger than a press contact load between the second roller and the fourth roller contacting each other via the image carrier belt and the transfer belt. According to this structure, the press contact load on the first transfer nip is larger than the press contact load on the second transfer nip. Thus, the function for increasing transferability at the first transfer nip and the function for increasing separability of the transfer material at the second transfer nip further improve.

It is preferable that the outside diameter of the second roller is larger than the outside diameter of the fourth roller. In this structure, separability of the transfer material at the second transfer nip is further increased.

An image forming apparatus according to a third aspect of the invention includes: a latent image carrier on which electrostatic latent image is formed; a developing device which develops the electrostatic latent image by liquid developer; an image carrier belt having a base layer and an elastic layer and receiving the transferred image of the latent image carrier; a first roller around which the image carrier belt is wound; a second roller around which the image carrier belt wound around the first roller and shifted; a third roller contacting the first roller via the image carrier belt; a fourth roller contacting the second roller via the image carrier belt. A hardness H4 of the fourth roller and a hardness H6 of the image carrier belt on the second roller when the image carrier belt is wound around the second roller have as the relationship of H6<H4. According to this structure, the image forming apparatus has preferable transferability and prevents winding of the transfer material around the image carrier belt.

It is preferable that the relationship between the hardness H4 of the fourth roller, a hardness H1 of the second roller, and a hardness H5 of the elastic layer of the image carrier belt have the relationship of H4≧H1 and H1>H5. According to this structure, the elastic layer of the image carrier belt contributes to the formation of the curved surface concaved on the second roller side at the second transfer nip. Accordingly, separability of the transfer material is increased, and winding of the transfer material around the image carrier belt is prevented.

An image forming apparatus according to a fourth aspect of the invention includes: a latent image carrier on which electrostatic latent image is formed; a developing device which develops the electrostatic latent image by liquid developer; an image carrier belt having a base layer and an elastic layer and receiving the transferred image of the latent image carrier; a first roller around which the image carrier belt is wound; a second roller around which the image carrier belt wound around the first roller and shifted; a third roller contacting the first roller via the image carrier belt; a fourth roller contacting the second roller via the image carrier belt; a transfer belt around which the third roller and the fourth roller are wound. A hardness H7 of the transfer belt on the fourth roller when the transfer belt is wound around the fourth roller and a hardness H6 of the image carrier belt on the second roller when the image carrier belt is wound around the second roller have the relationship of H6<H7. According to this structure, the elastic layer of the image carrier belt contributes to the formation of the curved surface concaved on the second roller side at the second transfer nip. Accordingly, separability of the transfer material is increased, and winding of the transfer material around the image carrier belt is prevented.

It is preferable that the relationship between the hardness H4 of the fourth roller, a hardness H1 of the second roller, and a hardness H5 of the elastic layer of the image carrier belt have the relationship of H4≧H1 and H1>H5. According to this structure, the elastic layer of the image carrier belt contributes to the formation of the curved surface concaved on the second roller side at the second transfer nip. Accordingly, separability of the transfer material is increased, and winding of the transfer material around the image carrier belt is prevented.

### BRIEF DESCRIPTION OF THE DRAWINGS

The invention will be described with reference to the accompanying drawings, wherein like numbers reference like elements.

FIG. 1 illustrates a first embodiment of the invention.

FIG. 2 illustrates the first embodiment of the invention.

FIG. 3 illustrates the first embodiment of the invention.

FIG. 4 illustrates a second embodiment of the invention.

FIG. 5 illustrates the second embodiment of the invention.

FIG. 6 illustrates the second embodiment of the invention.

FIG. 7 illustrates the second embodiment of the invention.

### DESCRIPTION OF EXEMPLARY EMBODIMENTS

Preferred embodiments according to the invention are hereinafter described with reference to the drawings.

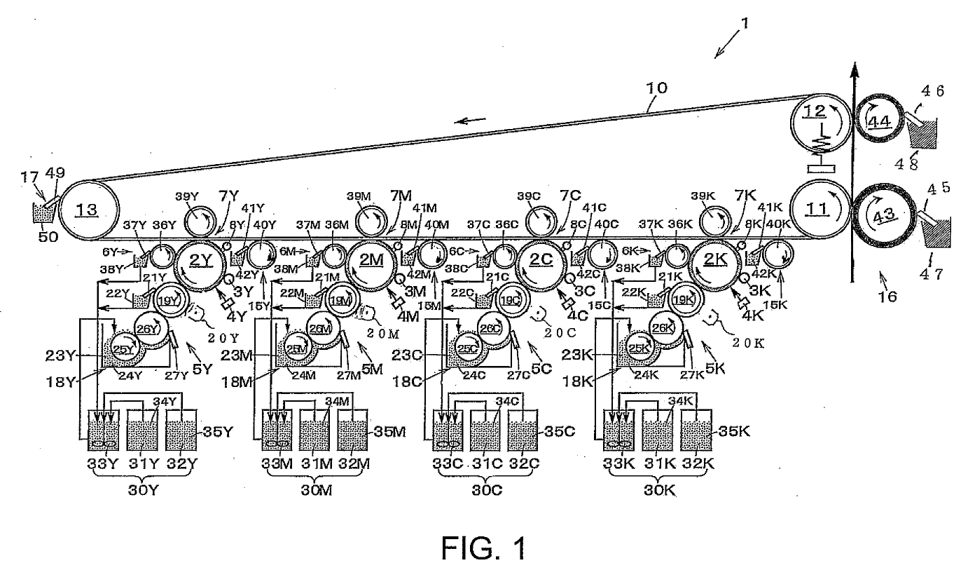

FIG. 1 illustrates an image forming apparatus according to a first embodiment of the invention.

As illustrated in FIG. 1, an image forming apparatus 1 in the first embodiment includes photosensitive bodies 2Y, 2M, 2C, and 2K as latent image carriers for yellow (Y), magenta (M), cyan (C), and black (B) disposed in tandem. The photosensitive bodies 2Y, 2M, 2C, and 2K correspond to yellow sensitive body, magenta sensitive body, cyan sensitive body, and black sensitive body, respectively. Other components are similarly represented by adding the respective colors Y, M, C, and K to the symbols of the components. According to the example shown in FIG. 1, the respective photosensitive bodies 2Y, 2M, 2C, and 2K are constituted by photosensitive drums. The photosensitive bodies 2Y, 2M, 2C, and 2K may have endless shapes.

These photosensitive bodies 2Y, 2M, 2C, and 2K rotate clockwise in the directions indicated by arrows shown in FIG. 1 during operation. Electrifiers 3Y, 3M, 3C, and 3K, exposing units 4Y, 4M, 4C, and 4K, developing devices 5Y, 5M, 5C, and 5K, photosensitive body squeezing devices 6Y, 6M, 6C, and 6K, primary transfer devices 7Y, 7M, 7C, and 7K, and charge removers 8Y, 8M, 8C, and 8K are provided around the photosensitive bodies 2Y, 2M, 2C, and 2K in this order from the upstream side of the rotation direction of the photosensitive bodies 2Y, 2M, 2C, and 2K. Not-shown photosensitive body cleaning units are disposed between the charge removers 8Y, 8M, 8C, and 8K and the electrifiers 3Y, 3M, 3C, and 3K.

An image forming apparatus 1 has an endless intermediate transfer belt 10 as an intermediate transfer medium. The intermediate transfer belt 10 wound around the belt driving roller 11 to which driving force of a not-shown motor is transmitted and a pair of following rollers 12 and 13 is rotatable anticlockwise as shown in FIG. 1. In this case, the belt driving roller 11 and one of the following rollers 12 are disposed adjacent to each other with a predetermined clearance therebetween in the shift direction of a transfer material such as paper to be transferred indicated by an arrow. The belt driving roller 11 and the other following roller 13 are disposed away from each other in the tandem direction of the photosensitive bodies 2Y, 2M, 2C, and 2K.

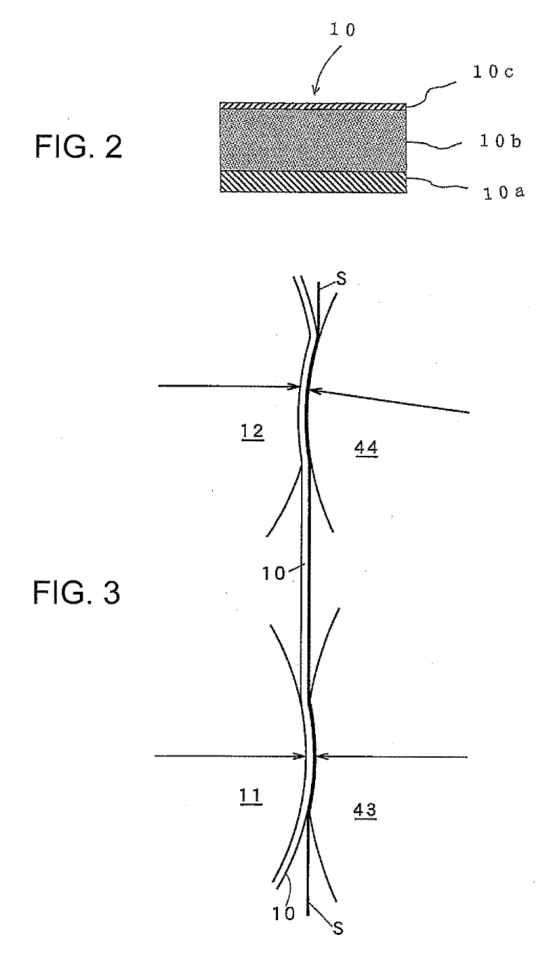

As illustrated in FIG. 2, the intermediate transfer belt 10 has a multilayer structure constituted by a base layer 10a, an elastic layer 10b laminated on the base layer 10a, and a surface layer 10c on the surface of the elastic layer 10b. The intermediate transfer belt 10 having the multilayer structure containing the elastic layer 10b has appropriate elasticity in the thickness direction, and thus improves transferability of the liquid developer images from the photosensitive bodies 2Y, 2M, 2C, and 2K and transferability onto the transfer material. Particularly, the intermediate transfer belt 10 has preferable transferability having large concaves and convexes, and can transfer clear images on concaves. The substrate layer 10a is made of polyimide resin, polyamideimide resin, or other material. The elastic layer 10b is made of conductive polyurethane rubber or the like. The surface layer 10c is made of fluororesin or the like.

According to the image forming apparatus 1 in this embodiment, the photosensitive bodies 2Y, 2M, 2C, and 2K and the developing devices 5Y, 5M, 5C, and 5K are disposed in the order of the colors Y, M, C, and K from the upstream side of the rotation direction of the intermediate transfer belt 10. However, the position order of the colors Y, M, C and K can be arbitrarily determined.

Intermediate transfer belt squeeze units 15Y, 15M, 15C, and 15K are disposed in the vicinity of the primary transfer devices 7Y, 7M, 7C, and 7K downstream from the primary transfer devices 7Y, 7M, 7C, and 7K in the rotation direction of the intermediate transfer belt 10. Furthermore, a secondary transfer device 16 is provided on the belt driving roller 11 side of the intermediate transfer belt 10, and an intermediate transfer belt cleaning unit 17 is provided on the following roller 13 side of the intermediate transfer belt 10.

Though not shown in the figure, the image forming apparatus 1 in this embodiment includes a transfer material storage unit for storing transfer material such as paper upstream from the secondary transfer device 16 in the transfer material shift direction, and a pair of resist rollers for supplying the transfer material from the transfer material storage unit toward the secondary transfer device 16 similarly to a typical image forming apparatus for performing secondary transfer. The image forming apparatus 1 similarly includes a fixing unit and a sheet discharge tray disposed downstream from the secondary transfer device 16 in the transfer material shift direction.

Each of the electrifiers 3Y, 3M, 3C, and 3K is constituted by an electrifying roller, for example. Bias voltage having the same polarity as that of the electrification polarity of the liquid developer is applied to each of the electrifiers 3Y, 3M, 3C, and 3K from a not-shown power source device. The electrifiers 3Y, 3M, 3C, and 3K electrify the corresponding photosensitive bodies 2Y, 2M, 2C, and 2K. The electrifiers 3Y, 3M, 3C, and 3K may be constituted by corona electrifiers. The exposing units 4Y, 4M, 4C, and 4K form electrostatic latent images on the corresponding electrified photosensitive bodies 2Y, 2M, 2C, and 2K by applying laser beams emitted from a laser scanning system, for example.

The developing devices 5Y, 5M, 5C, and 5K have developer supply units 18Y, 18M, 18C, and 18K, developing rollers 19Y, 19M, 19C, and 19K, toner electrifying corona electrifiers 20Y, 20M, 20C, and 20K, developing roller cleaners 21Y, 21M, 21C, and 21K, and developing roller cleaner collect liquid storage units 22Y, 22M, 22C, and 22K.

The developer supply units 18Y, 18M, 18C and 18K have developer containers 24Y, 24M, 24C, and 24K for containing liquid developers 23Y, 23M, 23C, and 23K constituted by toner particles and non-volatile liquid carriers, developer drawing rollers 25Y, 25M, 25C, and 25K, anilox rollers 26Y, 26M, 26C, and 26K, and developer regulating blades 27Y, 27M, 27C, and 27K.

Toners of the liquid developers 23Y, 23M, 23C, and 23K contained in the developer containers 24Y, 24M, 24C, and 24K are particles having average particle diameter of 1 μm and containing coloring agent such as known pigment dispersed in known thermoplastic resin for toners, for example. In case of liquid developer having low viscosity and low concentration, liquid carrier may be insulation liquid carrier such as Isopar (trademark: produced by Exxon Co.). In case of liquid developer having high viscosity and high concentration, liquid carrier may be silicon oil having flash point of 210 degrees or higher such as organic solvent, phenyl methyl siloxane, dimethyl polysiloxane, and polydimethylcyclosiloxane, mineral oil, aliphatic saturated hydrocarbon such as liquid paraffin having boiling point of 170 degrees or higher and relatively low viscosity of 3 mPa·s at 40 degrees, normal paraffin, vegetable oil, edible oil, higher fatty acid ester, or other insulation liquid carriers. The liquid developers 23Y, 23M, 23C, and 23K are formed by adding toner particles to liquid carriers together with dispersant to obtain toner solid concentration of approximately 20%.

The developer drawing rollers 25Y, 25M, 25C, and 25K draw the liquid developers 23Y, 23M, 23C, and 23K contained in the developer containers 24Y, 24M, 24C, and 24K and supplies the drawn liquid developers 23Y, 23M, 23C, and 23K to the anilox rollers 26Y, 26M, 26C, and 26K. The developer drawing rollers 25Y, 25M, 25C, and 25K rotate clockwise in the direction indicated by the arrow in FIG. 1. Each of the anilox rollers 26Y, 26M, 26C, and 26K has a cylindrical shape and a fine and uniform spiral groove on the surface. According to the dimensions of the groove, the groove pitch is about 170 μm, and the groove depth is about 30 μm, for example. Obviously, the dimensions of the groove are not limited to these values. The anilox rollers 26Y, 26M, 26C, and 26K rotate anticlockwise in the direction shown by the arrow in FIG. 1 as the same direction of the developing rollers 19Y, 19M, 19C, and 19K. The anilox rollers 26Y, 26M, 26C, and 26K may rotate by following the rotations of the developing rollers 19Y, 19M, 19C, and 19K. Thus, the rotation directions of the anilox rollers 26Y, 26M, 26C, and 26K are not limited but arbitrarily determined.

The developer regulating blades 27Y, 27M, 27C, and 27K contact the surfaces of the anilox rollers 26Y, 26M, 26C, and 26K. The developer regulating blades 27Y, 27M, 27C, and 27K have rubber portions formed by urethane rubber or the like contacting the corresponding surfaces of the anilox rollers 26Y, 26M, 26C, and 26K, and plates for supporting the rubber portions such as metal plates. The developer regulating blades 27Y, 27M, 27C, and 27K scrape liquid developers adhering to the surfaces of the anilox rollers 26Y, 26M, 26C, and 26K other than the grooves thereof by using the rubber portions to remove the remaining liquid developers. Thus, the anilox rollers 26Y, 26M, 26C, and 26K supply only liquid developer adhering to the inside of the grooves to the developing rollers 19Y, 19M, 19C, and 19K.

Each of the developing rollers 19Y, 19M, 19C, and 19K is a cylindrical component having approximately 320 mm in width, and has an elastic body such as conductive urethane rubber, a resin layer, and a rubber layer on the outer periphery of the metal shaft such as iron shaft. The developing rollers 19Y, 19M, 19C, and 19K contact the photosensitive bodies 2Y, 2M, 2C, and 2K, and rotate anticlockwise in the direction indicated by the arrow in FIG. 1.

Voltage is applied to the toner electrifying corona electrifiers 20Y, 20M, 20C, and 20K such that the electrifiers 20Y, 20M, 20C, and 20K can electrify the corresponding developing rollers 19Y, 19M, 19C, and 19K.

The developing roller cleaners 21Y, 21M, 21C, and 21K are constituted by rubber or the like contacting the surfaces of the corresponding developing rollers 19Y, 19M, 19C, and 19K to scrape and remove the developers remaining on the developing rollers 19Y, 19M, 19C, and 19K. The developing roller cleaner collect liquid storing units 22Y, 22M, 22C, and 22K are containers such as tanks for storing developers scraped from the developing rollers 19Y, 19M, 19C, and 19K by the developing roller cleaners 21Y, 21M, 21C, and 21K.

The image forming apparatus 1 in this embodiment further include developer replenishing devices 30Y, 30M, 30C, and 30K for replenishing the liquid developers 23Y, 23M, 23C, and 23K to the developer containers 24Y, 24M, 24C, and 24K. The developer replenishing devices 30Y, 30M, 30C, and 30K have toner tanks 31Y, 31M, 31C, and 31K, and carrier tanks 32Y, 32M, 32C, and 32K, and stirring units 33Y, 33M, 33C, and 33K.

The toner tanks 31Y, 31M, 31C, and 31K contain high-concentration liquid toners 34Y, 34M, 34C, 34K. The carrier tanks 32Y, 32M, 32C, and 32K contain liquid carriers (carrier oils) 35Y, 35M, 35C, and 35K. Predetermined amounts of high-concentration liquid toners 34Y, 34M, 34C, and 34K from the toner tanks 31Y, 31M, 31C, and 31K and predetermined amounts of liquid carriers 35Y, 35M, 35C, and 35K from the carrier tanks 32Y, 32M, 32C, and 32K are supplied to the stirring devices 33Y, 33M, 33C, and 33K.

The stirring devices 33Y, 33M, 33C, and 33K produce the liquid developers 23Y, 23M, 23C, and 23K used by the developing devices 5Y, 5M, 5C, and 5K by mixing and stirring the supplied high-concentration liquid toners 34Y, 34M, 34C, and 34K and the liquid carriers 35Y, 35M, 35C, and 35K. The liquid developers 23Y, 23M, 23C, and 23K produced by the stirring devices 33Y, 33M, 33C, and 33K are supplied to the developer containers 24Y, 24M, 24C, and 24K.

The photosensitive squeezing devices 6Y, 6M, 6C, and 6K have squeeze rollers 36Y, 36M, 36C, and 36K, squeeze roller cleaners 37Y, 37M, 37C, and 37K, and squeeze roller cleaner collect liquid storage containers 38Y, 38M, 38C, and 38K. The squeeze rollers 36Y, 36M, 36C, and 36K are disposed downstream from the contact portions (nip portions) between the photosensitive bodies 2Y, 2M, 2C, and 2K, and the developing rollers 19Y, 19M, 19C, and 19K in the rotation direction of the photosensitive bodies 2Y, 2M, 2C, and 2K. The squeeze rollers 36Y, 36M, 26C, and 36K rotate in the direction opposite to the direction of the photosensitive bodies 2Y, 2M, 2C, and 2K (anticlockwise in FIG. 1) to remove liquid carriers on the photosensitive bodies 2Y, 2M, 2C, and 2K.

Each of the squeeze rollers 36Y, 36M, 36C, and 36K is preferably formed by an elastic roller having an elastic material such as conductive urethane rubber and a fluororesin surface layer on the surface a metal core. The squeeze roller cleaners 37Y, 37M, 37C, and 37K are constituted by elastic bodies such as rubbers, and contact the surfaces of the corresponding squeeze rollers 36Y, 36M, 36C, and 36K to scrape and remove the liquid carriers remaining on the squeeze rollers 36Y, 36M, 36C, and 36K. The squeeze roller cleaner collect liquid storage containers 38Y, 38M, 38C, and 38K are containers such as tanks for storing developers scraped by the corresponding squeeze roller cleaners 37Y, 37M, 37C, and 37K.

The primary transfer devices 7Y, 7M, 7C, and 7K have primary transfer backup rollers 39Y, 39M, 39C, and 39K for achieving contact between the intermediate transfer belt 10 and the photosensitive bodies 2Y, 2M, 2C, and 2K. The backup rollers 39Y, 39M, 39C, and 39K receive about −200V having polarity opposite to that of the electrification polarity of toner particles, for example, to primarily transfer toner images (liquid developer images) in respective colors formed on the photosensitive bodies 2Y, 2M, 2C, and 2K onto the intermediate transfer belt 10. The charge removers 8Y, 8M, 8C, and 8K remove charges remaining on the photosensitive bodies 2Y, 2M, 2C, and 2K after primary transfer.

The intermediate transfer belt squeezing devices 15Y, 15M, 15C, and 15K have intermediate transfer belt squeeze rollers 40Y, 40M, 40C, and 40K, intermediate transfer belt squeeze roller cleaners 41Y, 41M, 41C, and 41K, intermediate belt squeeze roller cleaner collect liquid storage containers 42Y, 42M, 42C, and 42K. The intermediate transfer belt squeeze rollers 40Y, 40M, 40C, and 40K collect liquid carriers in the corresponding colors on the intermediate transfer belt 10. The intermediate transfer belt squeeze roller cleaners 41Y, 41M, 41C, and 41K scrape the collected liquid carriers on the intermediate transfer belt squeeze rollers 40Y, 40M, 40C, and 40K. The intermediate transfer belt squeeze roller cleaners 41Y, 41M, 41C, and 41K are formed by elastic bodies such as rubbers or the like similarly to the squeeze roller cleaners 37Y, 37M, 37C, and 37K. The intermediate transfer belt squeeze roller cleaner collect liquid storage containers 42Y, 42M, 42C, and 42K collect and store the liquid carriers scraped by the intermediate transfer belt squeeze roller cleaners 41Y, 41M, 41C, and 41K.

The secondary transfer device 16 has a pair of secondary transfer rollers disposed with a predetermined clearance therebetween in the transfer material shift direction. The secondary transfer roller of the pair of the rollers disposed on the upstream side in the shift direction of the transfer material is a first secondary transfer roller 43. The secondary transfer roller of the pair of the rollers disposed on the downstream side in the shift direction of the transfer material is a second secondary transfer roller 44. The first and second secondary transfer rollers 43 and 44 can contact the belt driving roller 11 and the following roller 12 via the intermediate transfer belt 10.

More specifically, the first and second secondary transfer rollers 43 and 44 bring the transfer material into close contact with the intermediate transfer belt 10 wound around the belt drive roller 11 and the following roller 12, and secondarily transfer a color toner image (liquid developer image) as a combination of toner images in respective colors formed on the intermediate transfer belt 10 onto the transfer material while shifting the transfer material closely contacting the intermediate transfer belt 10.

In this case, the belt drive roller 11 and the following roller 12 also function as backup rollers for the first and second transfer rollers 43 and 44 at the time of secondary transfer, respectively. More specifically, the belt drive roller 11 is also used as a first backup roller disposed on the secondary transfer device 16 on the upstream side from the following roller 12 in the shift direction of the transfer material, and the following roller 12 is also used as a second backup roller disposed on the downstream side from the belt driving roller 11 in the shift direction of the transfer material.

The load given for press contact between the first secondary transfer roller 43 and the belt drive roller 11 via the intermediate transfer belt 10 is larger than the load given for press contact between the second secondary transfer roller 44 and the following roller 12 via the intermediate transfer belt 10.

Thus, the transfer material shifted to the secondary transfer device 16 closely contacts the intermediate transfer belt 10 within a predetermined shift range of the transfer material from the press contact start position (nip start position) between the first secondary transfer roller 43 and the belt drive roller 11 (first backup roller) to the press contact end position (nip end position) between the second secondary transfer roller 44 and the following roller 12 (second backup roller). As a result, the full-color toner image on the intermediate transfer belt 10 is secondarily transferred on the transfer material under the condition in which the full-color toner image on the intermediate transfer belt 10 closely contacts the intermediate transfer belt for a predetermined period. Thus, preferable secondary transfer can be performed.

The diameter of the second secondary transfer roller 44 is smaller than that of the following roller 12. Thus, the transfer material is sandwiched between the intermediate transfer belt 10 and a transfer material support belt 52, and the passing smoothness of the transfer material at the secondary transfer position can be preferably maintained. Also, a transfer material S is easily separated from the intermediate transfer belt 10 after passing through the press contact position between the second secondary transfer roller 44 and the following roller 12.

The diameter of the second secondary transfer roller 44 is smaller than the first secondary transfer roller 43.

The liquid developers remaining on the first and second secondary transfer rollers 43 and 44 after secondary transfer are scraped by the secondary transfer roller cleaners 45 and 46, and then collected and stored in the secondary transfer roller cleaner collect liquid storage containers 47 and 48.

The intermediate transfer belt cleaning device 17 has an intermediate belt cleaner 49 and an intermediate transfer belt cleaner collect liquid storage container 50. The intermediate transfer belt cleaner 49 contacts the intermediate transfer belt 10 to scrape and remove the developers remaining on the surface of the intermediate transfer belt 10 after secondary transfer. In this case, the following roller 13 also functions as a backup roller at the time of intermediate transfer belt cleaning. The intermediate transfer belt cleaner 49 is formed by an elastic body such as rubber. The intermediate transfer belt cleaner collect liquid storage container 50 collects the developer scraped from the intermediate transfer belt 10 by using the intermediate transfer belt cleaner 49 and stores the collected developer.

Specific examples of the belt drive roller 11 (first backup roller), the first secondary transfer roller 43, the following roller 12 (secondary backup roller), the second secondary transfer roller 44, and the intermediate transfer belt 10 included in the transfer device according to the first embodiment are shown in Table 1.

TABLE 1

| | | | | Surface | |
|---|---|---|---|---|---|
| | | Outside | | layer | Electric |
| | | diameter | Hardness | thickness | resistance |
| Follower roller 12 | | φ30 mm | hardness | 2.5 mm | log7 |
| (2nd backup roller) | | | 40°(H1) | | |
| Second secondary | | φ20 mm | hardness | 1.0 mm | log7 |
| transfer roller 44 | | | 80°(H4) | | |
| Belt drive roller 11 | | φ30 mm | hardness | 0.5 mm | log7 |
| (1st backup roller) | | | 60°(H2) | | |
| First secondary transfer | | φ30 mm | hardness | 2.5 mm | log7 |
| roller 43 | | | 55°(H3) | | |
| Inter | Base layer 10a | | | 80 μm | log9 |
| mediate | (polyimide) | | | | |
| transfer | Elastic layer | | hardness | 600 μm | log9 |
| belt 10 | 10b | | 30°(H5) | | |
| | (conductive | | | | |
| | urethane | | | | |
| | rubber) | | | | |
| | Surface layer | | | 10 μm | log10 |
| | 10c | | | | |
| | (fluororesin) | | | | |

| | |
|---|---|
| Hardness of intermediate | hardness |
| transfer belt from surface | 60°(H6) |
| layer while wound | |
| around follower | |
| roller 12 | |

The hardness (H1 through H4) of each roller (11, 12, 43, and 44) is measured as type A in conformity with JIS-K6253. The hardness H5 of the elastic layer 10b of the intermediate transfer belt 10 is measured by removing the surface layer (coat layer) 10c and the base layer 10a to leave the elastic layer 10b only, and laminating layers in conformity with JIS-K6253 to measure the elastic layer 10b having a thickness of approximately 6 mm. The hardness H5 may be measured based on IRHD scale in conformity with JIS-K6253 with the surface layer 10c separated. The hardness H6 of the intermediate transfer belt 10 on the surface side while wound around the following roller 12 is measured based on the IRHD scale in conformity with JIS-K-6253. As described in JIS-K6253, the type A and the IRHD hardness can be used as the same rubber hardness level as shown in JIS-K6253. Thus, these scales are effective for comparison of which is higher or lower.

The measurement of electric resistance corresponds to a value at the time of application of 250V by highrester or UR probe.

FIG. 3 shows the shape of the transfer nip of the secondary transfer device 16 when the hardness (H1 through H4) of the rollers (11, 12, 43, and 44), the hardness H5 of the elastic layer 10b of the intermediate transfer belt 10, and the hardness H6 of the intermediate transfer belt 10 while wound around the following roller 12 are set at the values shown in Table 1.

As illustrated in FIG. 3, the hardness H2 (60°) of the belt drive roller 11 is larger than the hardness H3 of the first secondary transfer roller 43 (40°), and the hardness H3 of the first secondary transfer roller 43 is equal to or larger than the hardness H5 (30°) of the elastic layer 10b of the intermediate transfer belt 10 at the initial transfer nip of the secondary transfer device 16. When H2>H3 and H3≧H5, the first transfer nip as the press contact portion between the first secondary transfer roller 43 and the belt drive roller 11 via the intermediate transfer belt 10 becomes a curved surface concaved on the first secondary transfer roller 43 side. In this case, the width of the transfer nip can be secured, and transferability can be enhanced. Moreover, collect of the surplus carrier from the liquid developer image on the intermediate transfer belt 10 can be increased.

The hardness H4 (80°) of the second transfer roller 44 is larger than the hardness H1 (40°) of the following roller 12 (second backup roller). The hardness H1 of the following roller 12 (second backup roller) is larger than the hardness H5 (30°) of the elastic layer 10b of the intermediate transfer belt 10. The hardness H6 (60°) of the intermediate transfer belt 10 from the surface layer side while wound around the following roller 12 (second backup roller) is smaller than the hardness H4 (80°) of the second secondary transfer roller 44. When the second secondary transfer roller 44 press-contacts the following roller 12 (second backup roller) via the intermediate transfer belt 10 at the time of secondary transfer under the condition of H6<H4 as illustrated in FIG. 3, the press contact portion of the second secondary transfer roller 44 (second transfer nip) becomes a curved surface concaved on the following roller 12 side with the intermediate transfer belt 10. Thus, the separability of the transfer material S on the press contact portion (second transfer nip) of the second secondary transfer roller 44 is improved, and winding of the transfer material S around the intermediate transfer belt 10 can be prevented.

Therefore, the transfer material shifted to the secondary transfer device 16 closely contacts the intermediate transfer belt 10 within a predetermined shift region of the transfer material S from the press contact start position (first transfer nip start position) between the first secondary transfer roller 43 and the belt drive roller 11 (first backup roller) to the press contact end position (second transfer nip end position) between the second secondary transfer roller 44 and the following roller 12 (second backup roller). As a result, the full-color toner image on the intermediate transfer belt 10 is secondarily transferred on the transfer material with the full-color toner image on the intermediate transfer belt 10 closely contacting the intermediate transfer belt for a predetermined period. When the relationship between the hardness of the respective rollers and the hardness of the elastic layer 10b of the intermediate transfer belt 10 are set in the manner described above, the transferability at the first transfer nip and collect of the surplus carrier are enhanced. Moreover, separability of the transfer material S at the second transfer nip is increased, and preferable secondary transfer is performed with passing smoothness of the transfer material S and no winding thereof around the intermediate transfer belt.

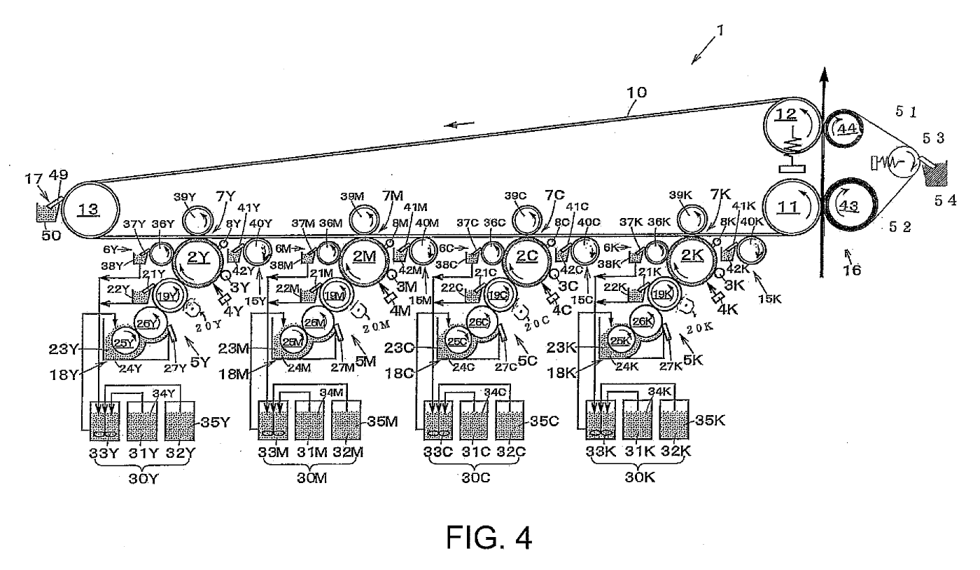

FIG. 4 illustrates an image forming apparatus according to a second embodiment of the invention. Similar reference numbers are given to components and elements similar to those in the first embodiment shown in FIG. 1, and the same explanation is not repeated.

The secondary transfer device 16 included in the image forming apparatus in the second embodiment has a pair of secondary transfer rollers disposed with a predetermined clearance therebetween in the shift direction of the transfer material. The secondary transfer roller of the pair of the rollers disposed on the upstream side in the shift direction of the transfer material is the first secondary transfer roller 43. The secondary transfer roller of the pair of the rollers disposed on the downstream side in the shift direction of the transfer material is the second secondary transfer roller 44. An endless transfer material support belt 52 is wound around the first and second secondary transfer rollers 43 and 44, and tension is given to the transfer material support belt 52 by a tension roller 51. The first and second secondary transfer rollers 43 and 44 can contact the belt drive roller 11 and the following roller 12, respectively, via the intermediate transfer belt 10 and the transfer material support belt 52. The transfer material support belt 52 is driven by the first secondary transfer roller 43. The transfer material support belt 52 is made of polyimide resin or polyamideimide resin.

More specifically, the transfer material support belt 52 wound around the first and second secondary transfer roller 43 and 44 achieves close contact between the transfer material and the intermediate transfer belt 10 wound around the belt drive roller 11 and the following roller 12. Also, the transfer material support belt 52 secondarily transfer the color toner image (liquid developer image) as a combination of the toner images in respective colors formed on the intermediate transfer belt 10 onto the transfer material while shifting the transfer material closely contacting the intermediate transfer belt 10.

In this case, the belt drive roller 11 and the following roller 11 are also used as backup rollers of the secondary transfer rollers 43 and 44, respectively, during the second transfer. More specifically, the belt drive roller 11 is also used as the first backup roller disposed on the secondary transfer device 16 on the upstream side from the following roller 12 in the shift direction of the transfer material, and the following roller 12 is also used as the second backup roller disposed on the downstream side from the belt driving roller 11 in the shift direction of the transfer material.

Thus, the transfer material shifted to the secondary transfer device 16 closely contacts the intermediate transfer belt 10 within the predetermined shift range of the transfer material from the press contact start position (nip start position) between the first secondary transfer roller 43 and the belt drive roller 11 to the press contact end position (nip end position) between the second secondary transfer roller 44 and the following roller 12. As a result, the full-color toner image on the intermediate transfer belt 10 is secondarily transferred on the transfer material with the full-color toner image on the intermediate transfer belt 10 closely contacting the intermediate transfer belt for a predetermined period. Thus, preferable secondary transfer can be performed.

The diameter of the second secondary transfer roller 44 is smaller than that of the following roller 12. Thus, the transfer material is sandwiched between the intermediate transfer belt 10 and the transfer material support belt 52, and the passing smoothness of the transfer material at the secondary transfer position can be maintained in a preferable condition. Moreover, the transfer material can be easily separated from the intermediate transfer belt 10 after passing through the press contact position between the second secondary transfer roller 44 and the following roller 12.

The secondary transfer device 16 also includes a transfer material support belt cleaner 53 and a transfer material support belt cleaner collect liquid storage container 54 for the transfer material support belt 52. The transfer material support belt cleaner 53 is formed by an elastic body such as rubber similarly to the squeezing roller cleaners 37Y, 37M, 37C, and 37K. The transfer material support belt cleaner 53 contacts the transfer material support belt 52 to scrape and remove foreign material such as liquid developer remaining on the surface of the transfer material support belt 52 after secondary transfer. The transfer material support belt cleaner collect liquid storage container 54 collects the developer scraped from the transfer material support belt 52 by using the transfer material support belt cleaner 53 and stores the collected developer. Thus, the next transfer material is free from the effect of foreign material such as liquid developer adhering to the transfer material support belt 52.

Specific examples of the belt drive roller 11 (first backup roller), the first secondary transfer roller 43, the following roller 12 (secondary backup roller), the second secondary transfer roller 44, the intermediate transfer belt 10, and the transfer material support belt 52 included in the transfer device according to the second embodiment are shown in Table 2.

TABLE 2

| | | | | Surface | |
|---|---|---|---|---|---|
| | | Outside | | layer | Electric |
| | | diameter | Hardness | thickness | resistance |
| Follower roller 12 | | φ30 mm | hardness | 2.5 mm | log7 |
| (second backup roller) | | | 40°(H1) | | |
| Second secondary | | φ20 mm | hardness | 1.0 mm | log7 |
| transfer roller 44 | | | 80°(H4) | | |
| Belt drive roller 11 | | φ30 mm | hardness | 0.5 mm | log7 |
| (first backup roller) | | | 60°(H2) | | |
| First secondary transfer | | φ30 mm | hardness | 2.5 mm | log7 |
| roller 43 | | | 40°(H3) | | |
| Inter | Base layer 10a | | | 80 μm | log9 |
| mediate | (polyimide) | | | | |
| transfer | Elastic layer | | hardness | 600 μm | log9 |
| belt 10 | 10b | | 30°(H2) | | |
| | (conductive | | | | |
| | urethane | | | | |
| | rubber) | | | | |
| | Surface layer | | | 10 μm | log10 |
| | 10c | | | | |
| | (fluororesin) | | | | |

| | | | |
|---|---|---|---|
| Transfer material support | | 80 μm | log9 |
| belt 50 polyimide | | | |
| Hardness of intermediate | hardness | | |
| transfer belt from surface | 60°(H6) | | |
| layer while wound | | | |
| around follower | | | |
| roller 12 | | | |
| Hardness of transfer | hardness | | |
| material support belt 50 | 90°(H7) | | |
| while wound around 2nd | | | |
| secondary transfer | | | |
| roller 44 | | | |

The hardness (H1 through H4) of each roller (11, 12, 43, and 44) is measured as type A in conformity with JIS-K6253. The hardness H5 of the elastic layer 10b of the intermediate transfer belt 10 is measured by removing the surface layer (coat layer) 10c and the base layer 10a to leave the elastic layer 10b only, and laminating layers in conformity with JIS-K6253 to measure the elastic layer 10b having a thickness of approximately 6 mm. The hardness H5 may be measured based on IRHD scale in conformity with JIS-K6253 with the surface layer 10c separated. The hardness H6 of the intermediate transfer belt 10 on the surface side while wound around the following roller 12 is measured based on the IRHD scale in conformity with JIS-K-6253. As described in JIS-K6253, the type A and the IRHD hardness can be used as the same rubber hardness level as shown in JIS-K6253. Thus, these scales are effective for comparison of which is higher or lower.

The measurement of electric resistance corresponds to a value at the time of application of 250V by highrester or UR probe.

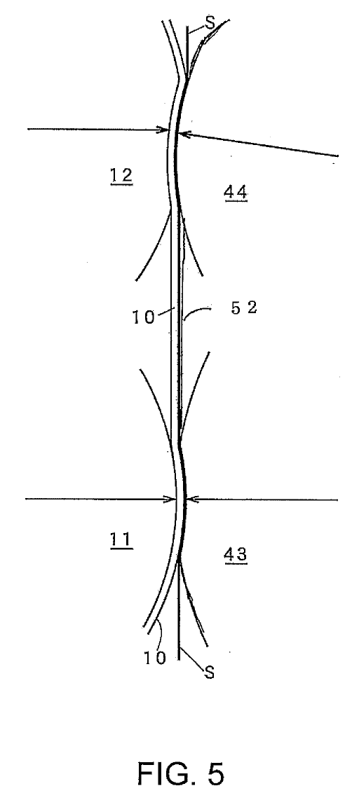

FIG. 5 shows the shape of the transfer nip of the secondary transfer device 16 when the hardness (H1 through H4) of the rollers (11, 12, 43, and 44), the hardness H5 of the elastic layer 10b of the intermediate transfer belt 10, the hardness H6 of the intermediate transfer belt 10 while wound around the following roller 12, and the hardness H7 of the transfer material support belt 52 wound around second secondary transfer roller 44 are set at the values shown in Table 2.

As illustrated in FIG. 5, the hardness H2 (60°) of the belt drive roller 11 is larger than the hardness H3 of the first secondary transfer roller 43 (40°) at the first transfer nip of the secondary transfer device 16. When H2>H3, the first transfer nip as the press contact portion between the first secondary transfer roller 43 and the belt drive roller 11 via the intermediate transfer belt 10 and the transfer material support belt 52 becomes a curved surface concaved on the first secondary transfer roller 43 side. In this case, the width of the transfer nip can be secured, and transferability can be enhanced. Moreover, collect of the surplus carrier from the liquid developer image on the intermediate transfer belt 10 can be increased.

The hardness 4 (80°) of the second transfer roller 44 is larger than the hardness H1 (40°) of the following roller 12 (second backup roller). The hardness H1 of the following roller 12 (second backup roller) is larger than the hardness H5 (30°) of the elastic layer 10b of the intermediate transfer belt 10. The hardness H6 (60°) of the intermediate transfer belt 10 while wound around the following roller 12 (second backup roller) from the surface layer side is smaller than the hardness H7 (90°) of the transfer material support belt 52 wound around the second secondary transfer roller 44. When the second secondary transfer roller 44 press-contacts the following roller 12 (second backup roller) via the intermediate transfer belt 10 and the transfer material support belt 52 at the time of secondary transfer under the condition of H6<H7 as illustrated in FIG. 5, the press contact portion of the second secondary transfer roller 44 (second transfer nip) becomes a curved surface concaved on the following roller 12 side with the intermediate transfer belt 10. Thus, the separability of the transfer material S on the press contact portion (second transfer nip) of the second secondary transfer roller 44 is increased, and winding of the transfer material S around the intermediate transfer belt 10 can be prevented.

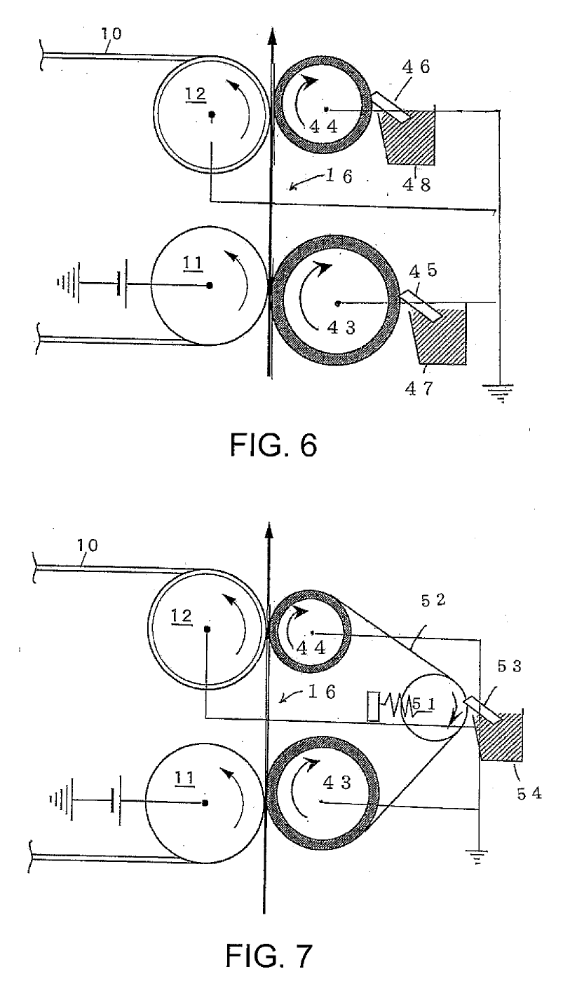

FIG. 6 illustrates the condition of secondary transfer using the transfer device according to the first embodiment. The press contact load of the second secondary transfer roller 44 given on the belt following roller 12 is 300 gf, and the press contact load of the first secondary transfer roller 43 given on the belt drive roller 11 is 45 kgf. Thus, the press contact load of the second secondary transfer roller 44 on the following roller 12 is smaller than the press contact load of the first secondary transfer roller 43 on the belt drive roller 11. The distance between the belt drive roller 11 and the first secondary transfer roller 43 and the distance between the following roller 12 and the second secondary transfer roller 44 are set at 28 mm. Direct current voltage (DC) as the transfer bias voltage in the range from +600 to 2,000V is applied with 200V for each to the belt drive roller 11. The other rollers 12, 43, and 44 are grounded (GND)

The base layer 10a of the intermediate transfer belt 10 is made of polyimide having a thickness of 100 μm as illustrated in FIG. 2. Also, the elastic layer 10b made of urethane rubber having a thickness of 600 μm is laminated on the base layer 10a, and the coat layer 10c coated with fluororesin having a thickness of 10 μm is covered on the elastic layer 10b to form a multilayer structure. The peripheral speed of the intermediate transfer belt 10 is 214 mm/sec.

The transfer toner concentration on the intermediate transfer belt before secondary transfer and the residual toner concentration on the intermediate transfer belt after secondary transfer are measured by using X-Lite optical measurement, and the transfer efficiency is calculated by the following equation.

transfer efficiency [%] for paper={(toner concentration before transfer−residual toner concentration after transfer)/(toner concentration before transfer)}×100

Every time direct current voltage (DC) as transfer bias voltage in the range from +600 to 2,000V is applied to the belt drive roller 11 with 200V for each, printing is performed on several sheets of Fuji Xerox J paper. Then, the toner concentration before transfer discussed above and the residual toner concentration after transfer discussed above are measured for each printing to calculate transfer efficiency, and the average transfer efficiency is obtained. According to the result of the experiment in the first embodiment, the transfer efficiency is 95% in the structure as the combination of the belt drive roller 11, the first secondary transfer roller 43, the following roller 12, the second secondary transfer roller 44, and the multilayer intermediate transfer belt 10 having the elastic layer 10b. In this case, winding of paper around the intermediate transfer belt 10 is not caused. According to the result of the experiment, the transfer efficiency is 85% in the structure as the combination of the belt drive roller 11, the first secondary transfer roller 43, and the multilayer intermediate transfer belt 10 having the elastic layer 10b as the structure including one backup roller and one secondary transfer roller for printing under the similar condition. Thus, it is conformed that preferable transfer with improved transfer efficiency and separability of transfer material can be performed in this embodiment.

FIG. 7 illustrates the condition of secondary transfer using the transfer device according to the second embodiment. The press contact load of the second secondary transfer roller 44 given on the belt following roller 12 is 300 gf, and the press contact load of the first secondary transfer roller 43 given on the belt drive roller 11 is 45 kgf. Thus, the press contact load of the second secondary transfer roller 44 on the following roller 12 is smaller than the press contact load of the first secondary transfer roller 43 on the belt drive roller 11. The distance between the belt drive roller 11 and the first secondary transfer roller 43 and the distance between the following roller 12 and the second secondary transfer roller 44 are set at 28 mm. Direct current voltage (DC) as the transfer bias voltage in the range from +600 to 2,000V is applied to the belt drive roller 11 with 200V for each. The other rollers 12, 43, and 44 are grounded (GND). The driving roller of the transfer material support belt 52 is the first secondary transfer roller 43. The peripheral speed of the intermediate transfer belt 10 is 214 mm/sec.

The base layer 10a of the intermediate transfer belt 10 is made of polyimide having a thickness of 100 μm as illustrated in FIG. 4. Also, the elastic layer 10b made of urethane rubber having a thickness of 600 μm is laminated on the base layer 10a, and the coat layer 10c coated with fluororesin having a thickness of 10 μm is covered on the elastic layer 10b to form a multilayer structure. The peripheral speed of the intermediate transfer belt 10 is 214 mm/sec.

The transfer toner concentration on the intermediate transfer belt before secondary transfer and the residual toner concentration on the intermediate transfer belt after secondary transfer are measured by using X-Lite optical measurement, and the transfer efficiency is calculated by the following equation.

transfer efficiency [%] for paper={(toner concentration before transfer−residual toner concentration after transfer)/(toner concentration before transfer)}100

Every time direct current voltage (DC) as transfer bias voltage in the range from +600 to 2,000V is applied with 200V for each, printing is performed on several sheets of Fuji Xerox J paper. Then, the toner concentration before transfer discussed above and the residual toner concentration after transfer discussed above are measured for each printing to calculate transfer efficiency, and the average transfer efficiency is obtained. According to the result of the experiment in the second embodiment, the transfer efficiency is 95% in the structure as the combination of the belt drive roller 11, the first secondary transfer roller 43, the following roller 12, the second secondary transfer roller 44, the transfer material support belt 52, and the intermediate transfer belt 10 of the multilayer structure having the elastic layer 10b. In this case, winding of paper around the intermediate transfer belt 10 is not caused. According to the result of the experiment, the transfer efficiency is 85% in the structure as the combination of the belt drive roller 11, the first secondary transfer roller 43, and the multilayer intermediate transfer belt 10 having the elastic layer 10b as the structure including one backup roller and one secondary transfer roller for printing under the similar condition. Thus, it is conformed that preferable transfer with improved transfer efficiency and separability of transfer material can be performed in this embodiment.

The entire disclosure of Japanese Patent Application Nos: 2007-237786, filed Sep. 13, 2007 and 2008-145726, filed Jun. 3, 2008 are expressly incorporated by reference herein.

What is claimed is:

1. A transfer device comprising:
an image carrier belt having a base layer and an elastic layer;
a first roller around which the image carrier belt is wound;
a second roller around which the image carrier belt is wound;
a third roller contacting the first roller via the image carrier belt; and
a fourth roller contacting the second roller via the image carrier belt,
wherein a hardness H4 of the fourth roller and a hardness H6 on the image carrier belt on the second roller when the image carrier belt is wound around the second roller have the relationship of H6<H4.

2. The transfer device according to claim 1, wherein:
the relationship between the hardness H4 of the fourth roller, a hardness H1 of the second roller, and a hardness H5 of the elastic layer of the image carrier belt have the relationship of H4≧H1 and H1>H5.

3. The transfer device according to claim 1, wherein:
the relationship between the hardness H2 of the first roller, a hardness H3 of the third roller, and the hardness H5 of the elastic layer of the image carrier belt have the relationship of H2>H3 and H3≧H5.

4. The transfer device according to claim 1, wherein a press contact load between the first roller and the third roller contacting each other via the image carrier belt is larger than a press contact load between the second roller and the fourth roller contacting each other via the image carrier belt.

5. The transfer device according to claim 1, wherein the outside diameter of the second roller is larger than the outside diameter of the fourth roller.

6. A transfer device, comprising:
an image carrier belt having a base layer and an elastic layer;
a first roller around which the image carrier belt is wound;
a second roller around which the image carrier belt wound around the first roller and shifted;
a third roller contacting the first roller via the image carrier belt;
a fourth roller contacting the second roller via the image carrier belt;
a transfer belt around which the third and fourth rollers are wound,
wherein a hardness H7 of the transfer belt on the fourth roller when the transfer belt is wound around the fourth roller and a hardness H6 of the image carrier belt on the second roller when the image carrier belt is wound around the second roller have the relationship of H6<H7.

7. The transfer device according to claim 6, wherein the relationship between the hardness H4 of the fourth roller, a hardness H1 of the second roller, and a hardness H5 of the elastic layer of the image carrier belt have the relationship of H4≧H1 and H1>H5.

8. The transfer device according to claim 6, wherein:
the relationship between the hardness H2 of the first roller, a hardness H3 of the third roller, and the hardness H5 of the elastic layer of the image carrier belt have the relationship of H2>H3 and H3≧H5.

9. The transfer device according to claim 6, wherein a press contact load between the first roller and the third roller contacting each other via the image carrier belt and the transfer belt is larger than a press contact load between the second roller and the fourth roller contacting each other via the image carrier belt and the transfer belt.

10. The transfer device according to claim 6, wherein the outside diameter of the second roller is larger than the outside diameter of the fourth roller.

11. An image forming apparatus comprising:
a latent image carrier on which electrostatic latent image is formed;
a developing device which develops the electrostatic latent image by liquid developer;
an image carrier belt having a base layer and an elastic layer and receiving the transferred image of the latent image carrier;
a first roller around which the image carrier belt is wound;
a second roller around which the image carrier belt is wound;
a third roller contacting the first roller via the image carrier belt;
a fourth roller contacting the second roller via the image carrier belt,
wherein a hardness H4 of the fourth roller and a hardness H6 of the image carrier belt on the second roller when the image carrier belt is wound around the second roller have the relationship of H6<H4.

12. The image forming apparatus according to claim 11, wherein the relationship between the hardness H4 of the fourth roller, a hardness H1 of the second roller, and a hardness H5 of the elastic layer of the image carrier belt have the relationship of H4≧H1 and H1>H5.
